(19) United States
(12) Patent Application Publication
(10) Pub. No.: US 2026/0296439 A1
(43) Pub. Date: Oct. 1, 2026

(54) TRAVEL CONTROL DEVICE, TRAVEL CONTROL METHOD, AND STORAGE MEDIUM

(71) Applicant: HONDA MOTOR CO., LTD., Tokyo (JP)

(72) Inventors: Yugo Kajiwara, Tokyo (JP); Daichi Kato, Tokyo (JP)

(21) Appl. No.: 19/536,285

(22) Filed: Feb. 11, 2026

(30) Foreign Application Priority Data
Mar. 28, 2025 (JP) 2025-055621

(51) Int. Cl. B60W 30/18; B60W 30/14; B60W 60/00

(52) U.S. Cl. CPC B60W 30/18163; B60W 30/14; B60W 30/143; B60W 60/001

(57) ABSTRACT

A travel control device includes a recognition unit that recognizes a peripheral situation of a host vehicle, a detection unit that detects at least one of a state of an occupant of the host vehicle and an instruction operation by the occupant, an action plan generation unit that generates first and second action plans of the host vehicle on the basis of a recognition result from the recognition unit and a detection result from the detection unit, and a travel control unit that controls at least one of steering and speed of the host vehicle to execute travel control of the host vehicle on the basis of the action plan, wherein the action plan generation unit regenerates the other action plan after either one of the first action plan and the second action plan is selected.

### CROSS-REFERENCE TO RELATED APPLICATION

This application claims priority based on Japanese Patent Application No. 2025-055621 filed in Japan on Mar. 28, 2025, and incorporates the entire contents thereof by reference.

### BACKGROUND OF THE INVENTION

### Field of the Invention

The present invention relates to a travel control device, a travel control method, and a storage medium.

### Description of Related Art

In recent years, efforts to provide access to sustainable transportation systems that take into consideration people in vulnerable positions among traffic participants have been intensifying. To achieve this, research and development are being focused on further improving traffic safety and convenience through research and development related to automated driving technology. In relation to this, conventionally, an action planning device is known that includes a scene generation unit that generates scene information indicating a situation in which a mobile body is placed by using peripheral information of the mobile body, a mode calculation unit that calculates in parallel a plurality of modes that are candidates for actions that the mobile body can take by using the scene information, and a mode selection unit that selects one from the modes calculated by the mode calculation unit and outputs it as an action of the mobile body (for example, see Patent Document 1 below).

### Patent Document 1

International Publication No. WO 2023-144938

### SUMMARY OF THE INVENTION

In automated driving technology, there has been a possibility that control is released when it becomes impossible to proceed during execution of a selected action plan. Therefore, there has been a problem that an action plan is not generated and appropriate travel control for a vehicle may not be executable.

An aspect according to the present invention has been made in consideration of such circumstances, and one of the objects is to provide a travel control device, a travel control method, and a storage medium capable of generating a more appropriate action plan according to a situation of a vehicle and improving continuity of travel control of the vehicle. Furthermore, it contributes to development of sustainable transportation systems.

In order to solve the above-described problem, the present invention employs the following aspects.
(1) A travel control device according to an aspect of the present invention includes: a recognition unit that recognizes a peripheral situation of a host vehicle; a detection unit that detects at least one of a state of an occupant of the host vehicle and an instruction operation by the occupant; an action plan generation unit that generates an action plan of the host vehicle on the basis of a recognition result from the recognition unit and a detection result from the detection unit; and a travel control unit that controls at least one of steering and speed of the host vehicle to execute travel control of the host vehicle on the basis of the action plan generated by the action plan generation unit, wherein the action plan generation unit includes: a first action plan generation unit that generates a first action plan on the basis of the recognition result from the recognition unit and a preset rule; and a second action plan generation unit that generates a second action plan with logic different from generation of the first action plan by the first action plan generation unit with respect to the recognition result from the recognition unit, and the action plan generation unit regenerates the other action plan after either one of the first action plan and the second action plan is selected.
(2) In the aspect of (1) above, the action plan generation unit may regenerate the other action plan after travel control on the basis of the selected one action plan is started by the travel control unit.
(3) In the aspect of (1) above, the action plan generation unit may regenerate the other action plan on the basis of the selected one action plan.
(4) In the aspect of (1) above, when it is determined by the travel control unit that travel control based on either one action plan of the first action plan and the second action plan is executable and travel control with the other action plan is not executable, the action plan generation unit may regard that travel control on the basis of the other action plan is possible on the basis of the either one action plan and regenerate the other action plan.
(5) In the aspect of (4) above, when it is determined that continuation of travel control is impossible during travel control on the basis of the either one action plan, the action plan generation unit may switch to travel control on the basis of the other action plan.
(6) In the aspect of (5) above, when it is determined that travel control on the basis of the other action plan is also impossible, the travel control unit may stop execution of the travel control.
(7) In the aspect of (1) above, the either one action plan may be the second action plan, and the other action plan may be the first action plan.
(8) In the aspect of (1) above, the travel control may include lane change control of the host vehicle, and the action plan generation unit may regenerate the other action plan after either one of the first action plan and the second action plan is selected when the lane change control is executed.
(9) A travel control method according to an aspect of the present invention is a method in which a computer: recognizes a peripheral situation of a host vehicle; detects at least one of a state of an occupant of the host vehicle and an instruction operation by the occupant; generates an action plan of the host vehicle on the basis of a recognition result and a detection result; controls at least one of steering and speed of the host vehicle to execute travel control of the host vehicle on the basis of the generated action plan; generates a first action plan on the basis of the recognition result and a preset rule; generates a second action plan with logic different from generation of the first action plan with respect to the recognition result; and regenerates the other action plan after either one of the first action plan and the second action plan is selected.
(10) A computer-readable non-transitory storage medium according to an aspect of the present invention stores a program for causing a computer to: recognize a peripheral situation of a host vehicle; detect at least one of a state of an occupant of the host vehicle and an instruction operation by the occupant; generate an action plan of the host vehicle on the basis of a recognition result and a detection result; control at least one of steering and speed of the host vehicle to execute travel control of the host vehicle on the basis of the generated action plan; generate a first action plan on the basis of the recognition result and a preset rule; generate a second action plan with logic different from generation of the first action plan with respect to the recognition result; and regenerate the other action plan after either one of the first action plan and the second action plan is selected.

According to the aspects of (1) to (10) above, a more appropriate action plan can be generated according to a situation of the host vehicle, and continuity of travel control of the host vehicle can be improved.

### BRIEF DESCRIPTION OF THE DRAWINGS

FIG. 1 is a configuration diagram of a vehicle system using a travel control device according to an embodiment.

FIG. 2 is a functional configuration diagram of a first control unit and a second control unit.

FIG. 3 is a diagram showing an example of a functional configuration of an action plan generation unit of the embodiment.

FIG. 4 is a diagram (part 1) for explaining a flow until an action plan is regenerated.

FIG. 5 is a diagram (part 2) for explaining a flow until an action plan is regenerated.

FIG. 6 is a diagram for explaining behavior of a host vehicle when a second target trajectory is no longer generated by a second action plan generation unit.

FIG. 7 is a flowchart showing an example of a flow of processing executed by an automated driving control device of the embodiment.

### DETAILED DESCRIPTION OF THE INVENTION

Hereinafter, embodiments of a travel control device, a travel control method, and a storage medium of the present invention will be described with reference to the drawings.

### Overall Configuration

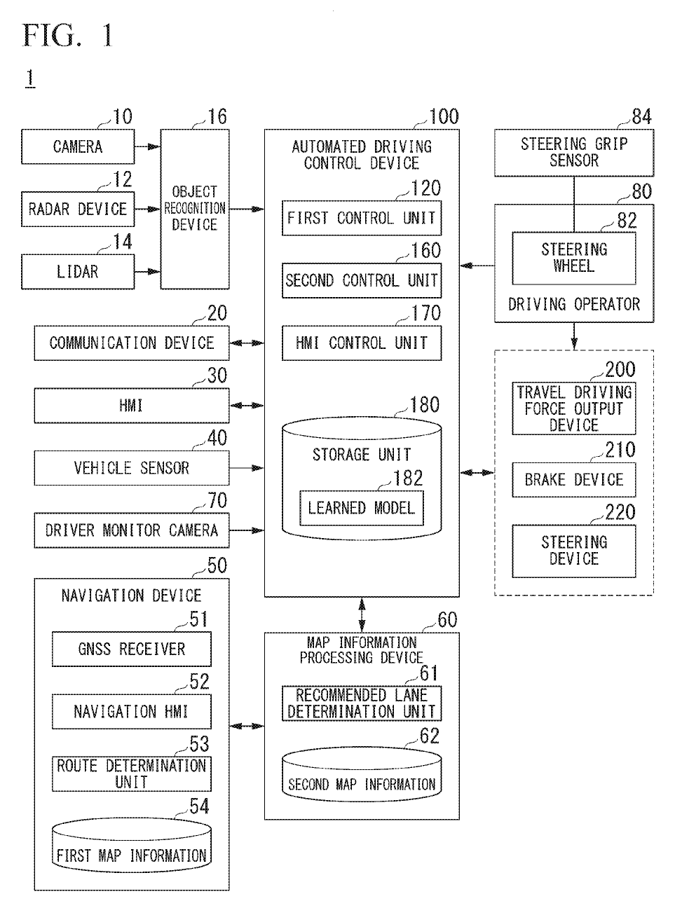

FIG. 1 is a configuration diagram of a vehicle system 1 using a travel control device according to the embodiment. A vehicle on which the vehicle system 1 is mounted is, for example, a two-wheeled, three-wheeled, four-wheeled, or other vehicle, and a drive source thereof is an internal combustion engine such as a diesel engine or a gasoline engine, an electric motor, or a combination thereof. The electric motor operates by using electric power generated by a generator connected to the internal combustion engine or discharge electric power of a secondary battery or a fuel cell. Hereinafter, as an example, an embodiment in which the travel control device is applied to an automated driving vehicle will be described. Automated driving is, for example, automatically controlling at least one of steering and speed of a vehicle to execute travel control. The above-described travel control of the vehicle includes, for example, various travel controls such as ACC (Adaptive Cruise Control System), LKAS (Lane Keeping Assistance System), TJP (Traffic Jam Pilot), ALC (Auto Lane Changing), and CMBS (Collision Mitigation Brake System). The travel control may include degraded driving (MRM; Minimum Risk Maneuver) control that moves the host vehicle M to a safe place (for example, a road shoulder or the like) and stops it. The automated driving vehicle may be controlled to be driven by manual driving of an occupant (driver).

The vehicle system 1 includes, for example, a camera 10, a radar device 12, a LIDAR (Light Detection and Ranging) 14, an object recognition device 16, a communication device 20, an HMI (Human Machine Interface) 30, a vehicle sensor 40, a navigation device 50, a map information processing device 60, a driver monitor camera 70, a driving operator 80, an automated driving control device 100, a traveling driving force output device 200, a brake device 210, and a steering device 220. These devices and equipment are connected to each other by a multiplex communication line such as a CAN (Controller Area Network) communication line, a serial communication line, a wireless communication network, or the like. The configuration shown in FIG. 1 is merely an example, and a part of the configuration may be omitted or another configuration may be added. The HMI 30 is an example of an "output unit". The automated driving control device 100 is an example of a "travel control device".

The camera 10 is, for example, a digital camera using a solid-state imaging element such as a CCD (Charge Coupled Device) or a CMOS (Complementary Metal Oxide Semiconductor). The camera 10 is attached to an arbitrary location of a vehicle on which the vehicle system 1 is mounted (hereinafter, host vehicle M). When imaging the front, the camera 10 is attached to an upper part of a front windshield, a back surface of a rearview mirror, or the like. The camera 10, for example, periodically and repeatedly images the periphery of the host vehicle M. The camera 10 may be a stereo camera.

The radar device 12 radiates radio waves such as millimeter waves to the periphery of the host vehicle M and detects radio waves (reflected waves) reflected by an object to detect at least a position (distance and azimuth) of the object. The radar device 12 is attached to an arbitrary location of the host vehicle M. The radar device 12 may detect a position and speed of an object by an FM-CW (Frequency Modulated Continuous Wave) method.

The LIDAR 14 irradiates light (or electromagnetic waves with a wavelength close to light) to the periphery of the host vehicle M and measures scattered light. The LIDAR 14 detects a distance to a target on the basis of a time from light emission to light reception. The irradiated light is, for example, pulsed laser light. The LIDAR 14 is attached to an arbitrary location of the host vehicle M.

The object recognition device 16 performs sensor fusion processing on detection results from some or all of the camera 10, the radar device 12, and the LIDAR 14, which are external world detection units, to recognize a position, a type, a speed, and the like of an object. The object recognition device 16 outputs a recognition result to the automated driving control device 100. The object recognition device 16 may output the detection result from the external world detection unit to the automated driving control device 100 as it is. The object recognition device 16 may be omitted from the vehicle system 1. The external world detection unit may include the object recognition device 16.

The communication device 20 communicates with other vehicles existing in the periphery of the host vehicle M or communicates with various server devices via a wireless base station by using, for example, a cellular network, a Wi-Fi network, Bluetooth (registered trademark), DSRC (Dedicated Short Range Communication), or the like.

The HMI 30 presents various information to an occupant of the host vehicle M under the control of an HMI control unit 170 and receives various input operations by the occupant. The HMI 30 includes, for example, various display devices, a speaker, a microphone, a buzzer, a touch panel, a switch, a key, and the like. The switch includes, for example, a turn signal switch (direction indicator). The HMI 30 receives, for example, an instruction regarding start and end of automated driving, an instruction to select a type of driving mode, an instruction to select any one of a plurality of action plans described later, an instruction regarding lighting of a direction indicator lamp by the turn signal switch, and the like, and outputs the received operation instruction to the automated driving control device 100.

The vehicle sensor 40 includes a vehicle speed sensor that detects a speed of the host vehicle M, an acceleration sensor that detects acceleration, a yaw rate sensor that detects an angular velocity around a vertical axis, an azimuth sensor that detects a direction of the host vehicle M, and the like.

The navigation device 50 includes, for example, a GNSS (Global Navigation Satellite System) receiver 51, a navigation HMI 52, and a route determination unit 53. The navigation device 50 holds first map information 54 in a storage device such as an HDD (Hard Disk Drive) or a flash memory. The GNSS receiver 51 specifies a position of the host vehicle M on the basis of a signal received from a GNSS satellite. The position of the host vehicle M may be specified or complemented by an INS (Inertial Navigation System) using an output of the vehicle sensor 40. The navigation HMI 52 includes a display device, a speaker, a touch panel, a key, and the like. The navigation HMI 52 may be partially or entirely shared with the HMI 30 described above. The route determination unit 53 determines, for example, a route (hereinafter, a map route) from a position of the host vehicle M specified by the GNSS receiver 51 (or an arbitrary position input) to a destination input by an occupant using the navigation HMI 52 with reference to the first map information 54. The first map information 54 is, for example, information in which a road shape is expressed by links indicating roads and nodes connected by the links. The first map information 54 may include a curvature of a road, POI (Point Of Interest) information, and the like. The map route is output to the map information processing device 60. The navigation device 50 may perform route guidance using the navigation HMI 52 on the basis of the map route. The navigation device 50 may be realized, for example, by a function of a terminal device such as a smartphone or a tablet terminal possessed by an occupant. The navigation device 50 may transmit a current position and a destination to a navigation server via the communication device 20 and acquire a route equivalent to the map route from the navigation server.

The map information processing device 60 includes, for example, a recommended lane determination unit 61 and holds second map information 62 in a storage device such as an HDD or a flash memory. The recommended lane determination unit 61 divides the map route provided from the navigation device 50 into a plurality of blocks (for example, divides every 100 [m] in a vehicle traveling direction) and determines a recommended lane for each block with reference to the second map information 62. The recommended lane determination unit 61 makes a determination such as which lane from the left to travel. For example, when a branch point exists on the map route, the recommended lane determination unit 61 determines a recommended lane so that the host vehicle M can travel on a rational route to proceed to a branch destination.

The second map information 62 is map information with higher accuracy than the first map information 54. The second map information 62 includes, for example, information on a center of a lane or information on a boundary of a lane. The second map information 62 may include road information, traffic regulation information, address information (address/postal code), facility information, telephone number information, and the like. The second map information 62 may be updated as needed by the communication device 20 communicating with another device. The first map information 54 and the second map information 62 may be integrally provided as map information. At least one of the first map information 54 and the second map information 62 may be stored in the automated driving control device 100.

The driver monitor camera 70 is, for example, a digital camera using a solid-state imaging element such as a CCD or a CMOS. The driver monitor camera 70 is attached to an arbitrary location in the host vehicle M, for example, at a position and in a direction capable of imaging a head of an occupant (hereinafter, driver) seated in a driver's seat of the host vehicle M from the front (in a direction to image a face). For example, the driver monitor camera 70 is attached to an upper part of a display device provided in a central part of an instrument panel of the host vehicle M.

The driving operator 80 includes, for example, a steering wheel 82, as well as an accelerator pedal, a brake pedal, a shift lever, and other operators. A sensor that detects an operation amount or presence or absence of an operation is attached to the driving operator 80, and a detection result thereof is output to the automated driving control device 100 or a part or all of the traveling driving force output device 200, the brake device 210, and the steering device 220. The steering wheel 82 is an example of an "operator that receives a steering operation by a driver". The operator does not necessarily have to be annular and may be in a form of a deformed steering wheel, a joystick, a button, or the like. A steering grip sensor 84 is attached to the steering wheel 82. The steering grip sensor 84 is realized by, for example, a capacitance sensor or the like, and outputs, to the automated driving control device 100, a signal capable of detecting whether or not the driver is gripping the steering wheel 82 (being in contact in a state in which force can be applied).

The automated driving control device 100 includes, for example, a first control unit 120, a second control unit 160, an HMI control unit 170, and a storage unit 180. The first control unit 120, the second control unit 160, and the HMI control unit 170 are each realized, for example, by a hardware processor such as a CPU (Central Processing Unit) executing a program (software). A part or all of these components may be realized by hardware (including circuitry) such as an LSI (Large Scale Integration), an ASIC (Application Specific Integrated Circuit), an FPGA (Field-Programmable Gate Array), or a GPU (Graphics Processing Unit), or may be realized by cooperation of software and hardware. The program may be stored in advance in a storage device (including a non-transitory storage medium) such as an HDD or a flash memory of the automated driving control device 100, or may be stored in a removable storage medium such as a DVD or a CD-ROM and installed in the HDD or flash memory of the automated driving control device 100 by the storage medium (non-transitory storage medium) being mounted on a drive device. The second control unit 160 is an example of a "travel control unit". The travel control unit may include a part of functions of the action plan generation unit 140. The HMI control unit 170 is an example of an "output control unit".

The storage unit 180 may be realized by the above-described various storage devices, or an SSD (Solid State Drive), an EEPROM (Electrically Erasable Programmable Read Only Memory), a ROM (Read Only Memory), or a RAM (Random Access Memory). In the storage unit 180, for example, a trained model 182, information necessary for executing travel control in the present embodiment, other various information, programs, and the like are stored. The storage unit 180 may store map information (for example, at least one of the first map information 54 and the second map information 62). Details of the trained model 182 will be described later.

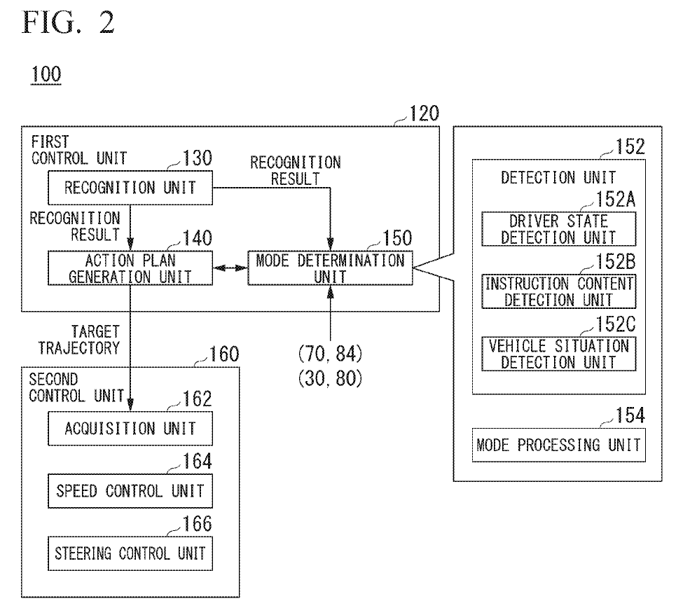

FIG. 2 is a functional configuration diagram of the first control unit 120 and the second control unit 160. The first control unit 120 includes, for example, a recognition unit 130, an action plan generation unit 140, and a mode determination unit 150. The first control unit 120 is realized, for example, by executing a function based on a model given in advance and a function based on AI (Artificial Intelligence) in parallel or by giving priority to one of them. For example, a function of "recognizing an intersection" may be realized by performing in parallel recognition based on a rule given in advance (a signal capable of pattern matching, a road marking, and the like exist) and recognition of an intersection by machine learning (for example, Neural Network) and scoring both and comprehensively evaluating them. Thereby, reliability of automated driving is ensured.

The recognition unit 130 recognizes a position of an object in the periphery of the host vehicle M and a state such as speed and acceleration on the basis of information input from external world detection units (for example, the camera 10, the radar device 12, and the LIDAR 14) via the object recognition device 16. The position of the object is recognized, for example, as a position on absolute coordinates with a representative point (center of gravity, drive shaft center, or the like) of the host vehicle M as an origin, and is used for control. The position of the object may be represented by a representative point such as a center of gravity or a corner of the object, or may be represented by a region. The "state" of the object may include acceleration or jerk of the object, or a "behavior state" (for example, whether or not a lane change is being made or is about to be made).

The recognition unit 130 recognizes, for example, a lane (travel lane) in which the host vehicle M is traveling. For example, the recognition unit 130 recognizes the travel lane by comparing a pattern (for example, an array of solid lines and broken lines) of road lane markings obtained from the second map information 62 with a pattern of road lane markings in the periphery of the host vehicle M recognized from an image captured by the camera 10. The recognition unit 130 may recognize the travel lane by recognizing a travel path boundary (road boundary) including not only road lane markings but also a road shoulder, a curb, a median strip, a guardrail, and the like. In this recognition, a position of the host vehicle M acquired from the navigation device 50 and a processing result from INS may be added. The recognition unit 130 recognizes a stop line, an obstacle, a red light, a toll gate, and other road events. The recognition unit 130 recognizes an adjacent lane adjacent to the travel lane. The adjacent lane is, for example, a lane capable of traveling in the same direction as the travel lane.

When recognizing the travel lane, the recognition unit 130 recognizes a position and a posture of the host vehicle M with respect to the travel lane. The recognition unit 130 may recognize, for example, a deviation of a reference point of the host vehicle M from a lane center and an angle formed with respect to a line connecting lane centers in a traveling direction of the host vehicle M as a relative position and posture of the host vehicle M with respect to the travel lane. Instead of this, the recognition unit 130 may recognize a position of a reference point of the host vehicle M with respect to either side end portion (road lane marking or road boundary) of the travel lane as a relative position of the host vehicle M with respect to the travel lane. Here, the reference point of the host vehicle M may be a center of the host vehicle M or a center of gravity. The reference point may be an end portion (front end portion, rear end portion) of the host vehicle M or a position where one of a plurality of wheels included in the host vehicle M exists.

The action plan generation unit 140 generates a target trajectory that the host vehicle M will automatically travel in the future (without depending on an operation of a driver) so that, for example, on the basis of a recognition result from the recognition unit 130, information acquired from the mode determination unit 150, and the like, the host vehicle M travels in the recommended lane determined by the recommended lane determination unit 61 in principle and can further cope with a peripheral situation of the host vehicle M. The target trajectory includes, for example, a speed element. For example, the target trajectory is expressed as a sequence of points (trajectory points) that the host vehicle M should reach. The trajectory point is a point that the host vehicle M should reach for each predetermined travel distance (for example, about several [m]) in a road-following distance, and separately from this, a target speed and target acceleration for each predetermined sampling time (for example, about 0.X [sec]) are generated as a part of the target trajectory. The trajectory point may be a position that the host vehicle M should reach at the sampling time for each predetermined sampling time. In this case, information on the target speed and target acceleration is expressed by an interval of trajectory points.

In the embodiment, the action plan generation unit 140 generates an action plan (first action plan) using a rule-based function given in advance as described above and an action plan (second action plan) using an AI-based function such as machine learning, and selects any one of the action plans according to a peripheral situation of the host vehicle M, a state of a driver, and the like. Here, generating an action plan is, for example, generating a future target trajectory of the host vehicle M. Details of the above-described contents will be described later.

When generating the target trajectory, the action plan generation unit 140 may activate an event (function) of automated driving. The event of automated driving includes a constant speed travel event, a low speed following travel event, a lane change event, a branch event, a merge event, a degraded driving event, a takeover event, and the like. The action plan generation unit 140 generates a target trajectory according to the activated event.

The mode determination unit 150 determines a driving mode of the host vehicle M according to a peripheral situation of the host vehicle M or a state of an occupant of the host vehicle M on the basis of at least one of, for example, a recognition result from the recognition unit 130, an image captured by the driver monitor camera 70, a detection result from the steering grip sensor 84, information received by the HMI 30, and operation contents of the driving operator 80. For example, the mode determination unit 150 determines a driving mode to be executed by the host vehicle M to be any one of a plurality of driving modes (in other words, a plurality of modes with different degrees of automation) with different tasks imposed on a driver according to a situation of the host vehicle M and a state of the driver.

Here, the driving mode in the embodiment includes, for example, a first driving mode and a second driving mode in which a degree of driving assistance is lower than in the first driving mode or a task of a driver of the host vehicle M is larger than in the first driving mode. The degree of driving assistance being low means, for example, that an automation rate in travel control is small. The automation rate being small means, for example, that a degree to which the automated driving control device 100 controls steering or speed of the host vehicle M is low (a degree of necessity for a driver to intervene in an operation of steering or speed is high). The task of the driver being large includes, for example, that the number of tasks imposed on the driver is large or the task is heavy. The task is, for example, that the driver monitors the periphery of the host vehicle M, that the driver operates the driving operator 80, or the like. The operation of the driving operator 80 includes, for example, that the driver enters a state of gripping the steering wheel (hereinafter, hands-on state). The driving mode may include a third driving mode in which the degree of driving assistance is lower than the second driving mode or the task of the driver of the host vehicle M is larger than the second driving mode. The driving mode in which the degree of driving assistance is lowest or the task of the driver of the host vehicle M is largest may be a completely manual driving mode (a mode in which travel control is not executed).

For example, in the first driving mode, there is no task of the driver (or it is lightest), and travel control (for example, ACC, LKAS, TJP, ALC, or the like) in a state (hereinafter, hands-off state) in which the driver of the host vehicle M is not gripping the steering wheel is permitted. In the second driving mode, a task imposed on the driver may include, for example, monitoring the periphery of the host vehicle M as well as being in a hands-on state.

The mode determination unit 150 outputs the determined mode to the action plan generation unit 140 and causes a target trajectory corresponding to the mode to be generated. The mode determination unit 150 includes, for example, a detection unit 152 and a mode processing unit 154. The detection unit 152 includes, for example, a driver state detection unit 152A, an instruction content detection unit 152B, and a vehicle situation detection unit 152C.

The driver state detection unit 152A detects whether or not an occupant (driver) is in a state suitable for driving (may be rephrased as whether or not the occupant is in an abnormal state). For example, the driver state detection unit 152A monitors a state of the driver for the above-described mode change and detects whether or not the state of the driver is a state according to a task. For example, the driver state detection unit 152A performs known image analysis processing (for example, matching processing such as edge, shape, size, color feature extraction, pattern matching, or the like) on an image captured by the driver monitor camera 70, performs driver posture estimation processing from an analysis result, and determines whether or not the driver is in a posture capable of manual driving (for example, a posture capable of shifting to manual driving in response to a request from a system). The driver state detection unit 152A may perform line-of-sight estimation processing from an analysis result of an image captured by the driver monitor camera 70 and determine whether or not the driver is monitoring the periphery (more specifically, the front) of the host vehicle M. The driver state detection unit 152A may determine whether or not the driver is gripping the steering wheel 82 on the basis of a detection result from the steering grip sensor 84. on the basis of these various determination results, when it is determined that the driver is not in a state according to a task for a predetermined time or more, the driver state detection unit 152A detects that the driver is not in a state suitable for driving (the driver is in an abnormal state), and when it is determined that the driver is in a state according to a task for a predetermined time or more, detects that the driver is in a state suitable for driving (the driver is not in an abnormal state).

The driver state detection unit 152A may detect that the driver is not in a state suitable for driving (the driver is in an abnormal state) when a facial expression of the driver that is not suitable for driving, such as a painful state or a sleepy state, continues for a predetermined time or more from an analysis result of an image captured by the driver monitor camera 70.

The instruction content detection unit 152B detects contents of an operation instruction of a driver received from the HMI 30 or the like. The contents of the operation instruction include, for example, an instruction regarding start and end of automated driving, an instruction to select a type of travel control or driving mode, an instruction to select any one of a plurality of action plans, and the like. The contents of the operation instruction may include an execution instruction of predetermined behavior control for the host vehicle M. The predetermined behavior control for the host vehicle M is, for example, ALC control (lane change control), but is not limited thereto, and may be any control as long as specific travel control (specific function) such as LKAS or specific steering or speed is executed. In the following description, as an example, it is assumed that the predetermined behavior control is ALC control.

The vehicle situation detection unit 152C detects a travel situation of the host vehicle M. The travel situation of the host vehicle M includes, for example, a current driving mode of the host vehicle M, a position of the host vehicle M on a road on the basis of a recognition result from the recognition unit 130, a speed, and the like. The vehicle situation detection unit 152C may detect information regarding a road situation (for example, a road shape, presence or absence, number, position (relative position), speed (relative speed) of other vehicles) during travel on the basis of a recognition result from the recognition unit 130, or may detect whether or not a lane marking that partitions a lane (travel lane) in which the host vehicle M travels is recognized. The vehicle situation detection unit 152C may detect that an adjacent lane adjacent to the travel lane exists on the basis of a recognition result from the recognition unit 130.

The mode processing unit 154 determines a driving mode of the host vehicle M on the basis of at least one of respective determination results from the driver state detection unit 152A, the instruction content detection unit 152B, and the vehicle situation detection unit 152C, and performs various processes for changing when a change of the driving mode is necessary.

For example, when a start instruction of the first driving mode is detected by the instruction content detection unit 152B during execution of the second driving mode of the host vehicle M, the mode processing unit 154 determines whether or not the first driving mode is executable on the basis of a determination result from the vehicle situation detection unit 152C, determines to switch to the first driving mode when it is determined that start is possible, and outputs switching to the first driving mode to the action plan generation unit 140.

When an execution instruction of specific travel control (for example, LKAS, ALC, or the like) of the first driving mode is detected by the instruction content detection unit 152B during execution of the first driving mode, the mode processing unit 154 determines whether or not a peripheral situation of the host vehicle M is a situation in which execution of the instructed travel control is possible, and determines to switch to the instructed travel control when it is determined to be executable. For example, when the instructed travel control is ALC, the mode processing unit 154 determines to execute ALC when the vehicle situation detection unit 152C detects a travel lane of the host vehicle M and an adjacent lane that is a lane change destination, and outputs an execution instruction of ALC to the action plan generation unit 140. When the instructed travel control is LKAS of the first driving mode, the mode processing unit 154 determines to execute LKAS when the vehicle situation detection unit 152C detects a lane marking that partitions a travel lane of the host vehicle M, and outputs an execution instruction of LKAS to the action plan generation unit 140.

When it is determined by the vehicle situation detection unit 152C that the first driving mode cannot be executed (continued) during execution of the first driving mode of the host vehicle M, the mode processing unit 154 determines to execute the second driving mode (for example, manual driving). A situation in which the first driving mode cannot be executed is, for example, a case where a lane marking of a travel lane of the host vehicle M cannot be recognized during execution of ALC control or LKAS control, a case where it is not a travel section in which the first driving mode is executable, a case where an abnormality has occurred in at least a part of an external world detection unit (camera 10, radar device 12, LIDAR 14) of the host vehicle M, or a case where recognition accuracy of surroundings by the recognition unit 130 has deteriorated due to an influence of weather such as heavy rain or snow accumulation.

When it is determined to switch from the first driving mode to the second driving mode, the mode processing unit 154 causes the HMI control unit 170 to control the HMI 30 to prompt the driver to execute a predetermined task for switching to the second driving mode. The predetermined task here is, for example, monitoring of the periphery of the host vehicle M by the driver or gripping of the steering wheel 82. For example, when it is determined by the driver state detection unit 152A that the driver is in a state suitable for driving, it is determined to switch to the second driving mode, and switching to the second driving mode is output to the action plan generation unit 140.

When a predetermined time has elapsed since information for prompting the driver to execute a predetermined task for switching to the second driving mode was output from the HMI 30 and the task has not been executed, or when it is determined by the driver state detection unit 152A that the driver is not in a state suitable for driving, the mode processing unit 154 determines to activate (execute) degraded driving control such as stopping (ending) the first driving mode by causing the host vehicle M to move toward and gradually stop at a road shoulder or the like without depending on an operation of the driver. An action plan generation instruction according to degraded driving is output to the action plan generation unit 140. After stopping automated driving, the host vehicle M shifts to a driving mode with a low degree of automation, and it becomes possible to start the host vehicle M by a manual operation of the driver.

Even when the instruction content determined by the instruction content detection unit 152B is switching of the second driving mode during execution of the first driving mode, the mode processing unit 154 similarly determines whether or not the driver is in a state suitable for driving of the second driving mode and performs processing according to the determination result. When it is determined that the driver is not in a state suitable for driving (the driver is in an abnormal state) during execution of the first driving mode, the mode processing unit 154 may determine to activate (execute) the above-described degraded driving control and instruct the action plan generation unit 140 to that effect. The mode processing unit 154 may output a state of the driver (for example, that the driver is not in a state suitable for driving of the host vehicle M) to the action plan generation unit 140.

The second control unit 160 controls the traveling driving force output device 200, the brake device 210, and the steering device 220 so that the host vehicle M passes through a target trajectory (more specifically, a target trajectory selected from a plurality of action plans (target trajectories)) generated by the action plan generation unit 140 at a scheduled time.

The second control unit 160 includes, for example, an acquisition unit 162, a speed control unit 164, and a steering control unit 166. The acquisition unit 162 acquires information on a target trajectory (trajectory point) generated by the action plan generation unit 140 and stores it in a memory (not shown). The speed control unit 164 controls the traveling driving force output device 200 or the brake device 210 on the basis of a speed element associated with the target trajectory stored in the memory. The steering control unit 166 controls the steering device 220 according to a curvature of the target trajectory stored in the memory. Processing of the speed control unit 164 and the steering control unit 166 is realized, for example, by a combination of feedforward control and feedback control. As an example, the steering control unit 166 executes a combination of feedforward control according to a curvature of a road ahead of the host vehicle M and feedback control based on deviation from a target trajectory.

The HMI control unit 170 notifies an occupant (including a driver) of the host vehicle M of predetermined information by the HMI 30. The predetermined information includes, for example, information related to travel of the host vehicle M such as information regarding a state of the host vehicle M and information regarding travel control. The information regarding the state of the host vehicle M includes, for example, a speed of the host vehicle M, an engine rotation speed, a shift position, and the like. The information regarding travel control may include, for example, presence or absence of execution of automated driving, information regarding change of travel control or driving mode, information regarding a situation of travel control (for example, contents of an event being executed), information regarding a situation of a driving mode (a driving mode being executed), and the like. The predetermined information may include information not related to travel control of the host vehicle M, such as a TV program, content (for example, a movie) stored in a storage medium such as a DVD. The predetermined information may include, for example, information regarding a current position of the host vehicle M, a destination, and a remaining amount of fuel.

For example, the HMI control unit 170 may generate an image including the above-described predetermined information and display the generated image on a display device of the HMI 30, or may generate a voice indicating the predetermined information and output the generated voice from a speaker of the HMI 30. The HMI control unit 170 may output information received by the HMI 30 to the communication device 20, the navigation device 50, the first control unit 120, or the like.

The traveling driving force output device 200 outputs traveling driving force (torque) for a vehicle to travel to driving wheels. The traveling driving force output device 200 includes, for example, a combination of an internal combustion engine, an electric motor, a transmission, and the like, and an ECU (Electronic Control Unit) that controls these. The ECU controls the above-described configuration according to information input from the second control unit 160 or information input from the driving operator 80.

The brake device 210 includes, for example, a brake caliper, a cylinder that transmits hydraulic pressure to the brake caliper, an electric motor that generates hydraulic pressure in the cylinder, and a brake ECU. The brake ECU controls the electric motor according to information input from the second control unit 160 or information input from the driving operator 80 so that brake torque according to a braking operation is output to each wheel. The brake device 210 may include, as a backup, a mechanism that transmits hydraulic pressure generated by an operation of a brake pedal included in the driving operator 80 to the cylinder via a master cylinder. The brake device 210 is not limited to the above-described configuration and may be an electronically controlled hydraulic brake device that controls an actuator according to information input from the second control unit 160 to transmit hydraulic pressure of the master cylinder to the cylinder.

The steering device 220 includes, for example, a steering ECU and an electric motor. The electric motor, for example, applies force to a rack and pinion mechanism to change a direction of steered wheels. The steering ECU drives the electric motor according to information input from the second control unit 160 or information input from the steering wheel 82 of the driving operator 80 to change the direction of the steered wheels.

### Action Plan Generation Unit

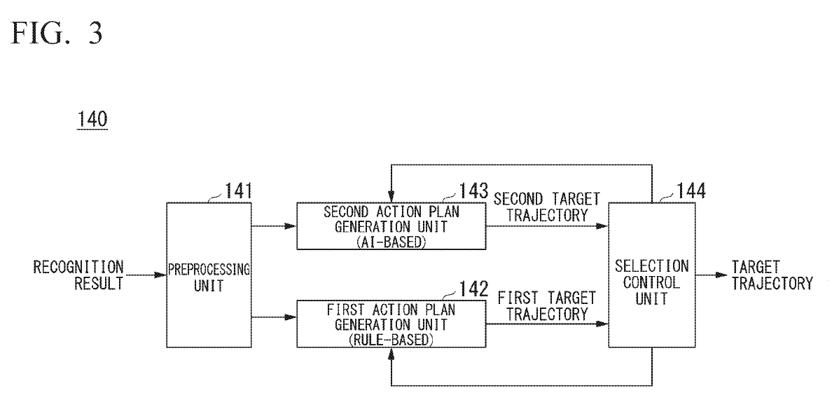

Hereinafter, processing of the action plan generation unit 140 will be specifically described. FIG. 3 is a diagram showing an example of a functional configuration of the action plan generation unit 140 of the embodiment. The action plan generation unit 140 includes, for example, a preprocessing unit 141, a first action plan generation unit 142, a second action plan generation unit 143, and a selection control unit 144.

The preprocessing unit 141 determines a rough policy of future behavior of the host vehicle M on the basis of a recognition result from the recognition unit 130 and information determined by the mode determination unit 150, and sets semantics (target trajectory generation conditions) necessary for generating a target trajectory from the behavior. For example, when an execution instruction of ALC control is received, a target trajectory generation condition (semantics) for changing a lane to a lane change destination lane instructed is set, and when an execution instruction of LKAS control is received, a target trajectory generation condition (semantics) for traveling at a center of a current travel lane is set. The preprocessing unit 141 may predict future behavior of a target such as another vehicle existing in the periphery of the host vehicle M on the basis of a recognition result. The preprocessing unit 141 outputs the above-described setting result, prediction result, and recognition result from the recognition unit 130 to the first action plan generation unit 142 and the second action plan generation unit 143.

When an activation (execution) instruction of degraded driving control is received by the mode determination unit 150, the preprocessing unit 141 may output the activation instruction of degraded driving control to, for example, at least one of the first action plan generation unit 142 and the second action plan generation unit 143 or a predetermined one of them. When an execution instruction of the second driving mode (for example, manual driving) is received by the mode determination unit 150, the preprocessing unit 141 may output an instruction to end generation of an action plan (target trajectory) to the first action plan generation unit 142 and the second action plan generation unit 143. However, processing of causing the first action plan generation unit 142 and the second action plan generation unit 143 to perform an action plan may be continued even during execution of manual driving. In this case, the selection control unit 144 does not select any action plan.

The function of the preprocessing unit 141 may be incorporated in each of the first action plan generation unit 142 and the second action plan generation unit 143, and in that case, the configuration of the preprocessing unit 141 may not be provided.

The first action plan generation unit 142 generates an action plan (first action plan), on the basis of information acquired from the preprocessing unit 141, according to a preset rule (constraint condition or the like). For example, when ALC, LKAS, or the like by the first driving mode is instructed, the first action plan generation unit 142 generates a future target trajectory (first target trajectory) of the host vehicle M on the basis of an optimization problem on the basis of various constraint conditions on the basis of rules so that the instructed driving mode or driving control can be achieved.

For example, when executing ALC control, the first action plan generation unit 142 sets a target position of the host vehicle M on a lane change destination lane (adjacent lane), and generates an optimal first target trajectory that satisfies the constraint conditions, with a constraint condition of moving to the target position within a predetermined time without contacting other vehicles or the like in the periphery of the host vehicle M. The optimal target trajectory is, for example, a target trajectory in which a change amount of behavior of the host vehicle M is smallest, or a target trajectory in which a possibility of contact with an obstacle such as another vehicle is smallest. For example, when executing LKAS control, the first action plan generation unit 142 generates an optimal first target trajectory (first vehicle trajectory) that satisfies the constraint conditions, with constraint conditions of a reference point (for example, a center of gravity or a center of the host vehicle M) of the host vehicle M passing over a center of a lane partitioned by left and right lane markings, and traveling at a legal speed of the lane or a speed that does not allow contact with other vehicles existing in front of and behind the vehicle. In this way, the first action plan generation unit 142 generates a rule-based first target trajectory that satisfies each rule and is optimal by comparing information acquired by the mode determination unit 150 with all information such as external world information (recognition result) and each rule (constraint condition).

Since the first target trajectory generated by the first action plan generation unit 142 is generated on the basis of a predetermined rule, the first target trajectory is easily stable as vehicle behavior, and particularly in a lane change or the like, smooth (sequential) behavior can be achieved. However, in the first action plan generation unit 142, when the periphery of the host vehicle M is a complex traffic environment, it may take time to find a solution that satisfies given constraint conditions, or a solution may not be found, so there is a possibility that appropriate automated driving cannot be executed.

The second action plan generation unit 143 generates an action plan (second action plan) on the basis of a model (trained model 182) trained to generate an action plan on the basis of external world information (recognition result) or the like on the basis of information processed by the preprocessing unit 141. For example, when ALC, LKAS, or the like by the first driving mode is instructed, the second action plan generation unit 143 generates a target trajectory (second target trajectory) such that travel control according to instructed contents is achieved using an inference-based (AI-based) approach based on the trained model 182. That is, the second action plan generation unit 143 generates a second action plan with logic different from generation of the first action plan by the first action plan generation unit 142.

For example, the second action plan generation unit 143 uses machine learning (for example, Neural-Network) or deep learning to train in advance a model that takes external world information (for example, recognition result) and semantic information as input and outputs a second target trajectory inferred to be optimal by using teacher data (correct answer data), past performance data, or the like. Then, the second action plan generation unit 143 acquires a second target trajectory inferred to be optimal by inputting information processed by the preprocessing unit 141 to the trained model 182 (inference device). The trained model 182 may be acquired from an external device via the communication device 20 or may be trained by the second action plan generation unit 143. The data of the trained model 182 may be updated by executing feedback control based on correct answer data each time it is used.

The second target trajectory generated by the second action plan generation unit 143 can infer by capturing the environment globally (roughly) even in a complex traffic environment, so it becomes a target trajectory according to a determined instruction even in a situation (peripheral situation) that has not been traveled in in the past. Therefore, automated driving can be continued without stopping the host vehicle M. However, the second target trajectory may have a possibility that the behavior of the host vehicle M is not stable because a completely different target trajectory may be easily output when external world information changes even slightly.

The selection control unit 144 selects either one of the first target trajectory (an example of the first action plan) generated by the first action plan generation unit 142 and the second target trajectory (an example of the second action plan) generated by the second action plan generation unit 143. For example, the selection control unit 144 preferentially uses a preset one of the two target trajectories (action plans), and when the one being used reaches a predetermined situation such as a performance limit, uses the other target trajectory. For example, when the trained model 182 is not yet mature immediately after shipment of the host vehicle M or the like, the selection control unit 144 selects the rule-based first target trajectory generated by the first action plan generation unit 142, and when the trained model 182 has matured (for example, when the host vehicle M has traveled a predetermined distance or more or for a predetermined time or more and the trained model 182 has been updated according to a travel result), selects the second target trajectory generated by the second action plan generation unit 143.

The selection control unit 144 may select a target trajectory according to an instruction from a driver received by the HMI 30 from among the first target trajectory and the second target trajectory. Thereby, the host vehicle M can be caused to travel on a target trajectory desired by the driver.

The acquisition unit 162 of the second control unit 160 adjusts a control amount related to travel control of the host vehicle M such as speed and steering on the basis of the target trajectory selected by the selection control unit 144, outputs the control amount for speed to the speed control unit 164, and outputs the control amount for steering to the steering control unit 166, whereby travel control according to the target trajectory is executed. In this way, in the embodiment, by two types of target trajectories (action plans) being generated by the action plan generation unit 140, a more appropriate target trajectory can be selected corresponding to various travel scenes and the host vehicle M can be caused to travel.

Here, the action plan generation unit 140 regenerates the other target trajectory after either one of the first target trajectory and the second target trajectory is selected by the selection control unit 144. For example, as shown in FIG. 3, the selection control unit 144 outputs information regarding selected contents to the first action plan generation unit 142 and the second action plan generation unit 143. The first action plan generation unit 142 and the second action plan generation unit 143 receive information on whether or not a target trajectory generated by itself has been selected, and regenerate an action plan even when it is not selected.

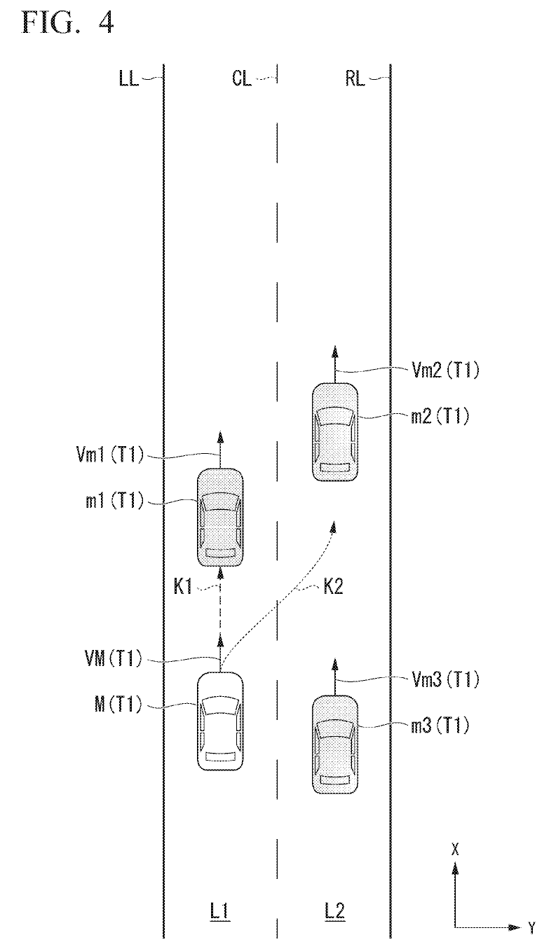

FIG. 4 is a diagram (part 1) for explaining a flow until an action plan is regenerated. In the example of FIG. 4, two lanes L1 and L2 capable of traveling in the same direction (X-axis direction in the figure) are shown. The lane L1 is partitioned by lane markings LL and CL, and the lane L2 is partitioned by lane markings CL and RL. The host vehicle M is traveling in the lane L1 at a speed VM. In the example of FIG. 4, other vehicles m1 to m3 exist in the periphery of the host vehicle M. The other vehicle m1 is traveling on the lane L1 at a speed Vm1 in front of the host vehicle M, the other vehicle m2 is traveling on the lane L2 at a speed Vm2 in front of the host vehicle M, and the other vehicle m3 is traveling on the lane L2 at a speed Vm3 on the right side of the host vehicle M. In the following description, positions of the host vehicle M and the other vehicles m1 to m3 at time T* are represented as M(T*), m1(T*), m2(T*), and m3(T*), respectively, and speeds are represented as VM(T*), Vm1(T*), Vm2(T*), and Vm3(T*), respectively. In the following description, it is assumed that T1 is earliest, followed by times T2 and T3 in that order. The recognition unit 130 recognizes a travel lane L1 and an adjacent lane L2 of the host vehicle M, and recognizes positions (relative positions) and speeds (relative speeds) of the other vehicles m1 to m3.

The example of FIG. 4 shows a situation at time T1. In the situation shown in FIG. 4, for example, when an ALC instruction by an occupant (for example, a lane change instruction from the lane L1 to the lane L2 by a turn signal switch) is received by the instruction content detection unit 152B during execution of the first driving mode, the mode determination unit 150 outputs an execution instruction of ALC control by the first driving mode to the action plan generation unit 140. on the basis of a peripheral situation and a rule (constraint condition), the first action plan generation unit 142 determines that the other vehicles m1(T1) to m3(T1) exist in the periphery of the host vehicle M(T1) and that lane change (overtaking or the like) cannot be performed from a relationship of positions and speeds, and as shown in FIG. 4, generates a first target trajectory K1 that goes straight without changing lanes and decelerates so as not to contact the other vehicle m1.

On the other hand, on the basis of the trained model 182, the second action plan generation unit 143 generates a second target trajectory K2 that changes lanes from the lane L1 to the lane L2 as shown in FIG. 4. The second target trajectory K2 shown in FIG. 4 is, for example, a target trajectory that could not be generated by the rule basis of the first action plan generation unit 142, and is assumed to be a target trajectory in which a change in behavior of the host vehicle M is relatively large such that a lane change can barely be performed.

Here, the selection control unit 144 selects either one of the two action plans (first target trajectory K1, second target trajectory K2) on the basis of a preset priority, an instruction of a driver, or the like. Here, it is assumed that the second target trajectory K2 is selected. Thereby, the travel control unit (second control unit 160) starts lane change control of the host vehicle M based on the second target trajectory K2.

Here, the selection control unit 144 outputs selected information to the first action plan generation unit 142 and the second action plan generation unit 143. The second action plan generation unit 143 is the one selected, so it continues to generate the second target trajectory K2. On the other hand, the first action plan generation unit 142 that is not selected regenerates the first target trajectory K1.

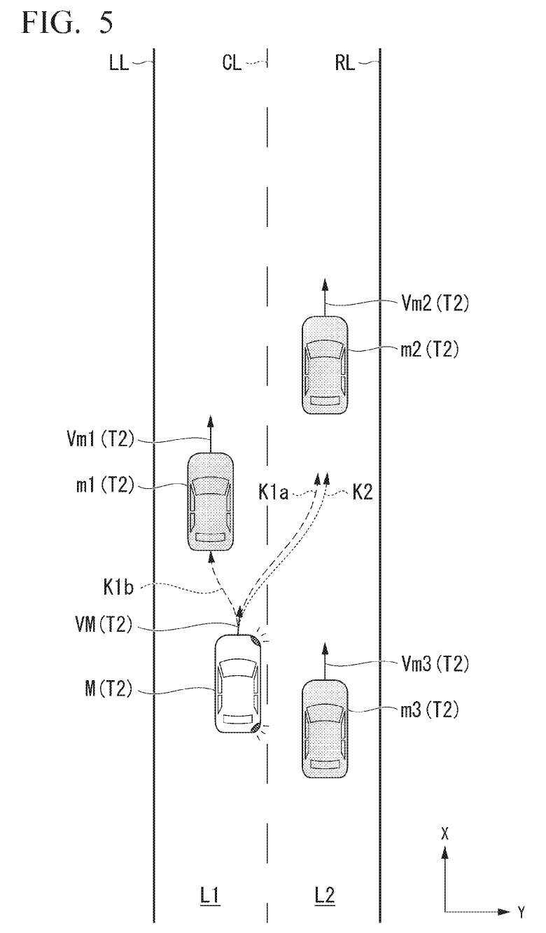

FIG. 5 is a diagram (part 2) for explaining a flow until an action plan is regenerated. The example of FIG. 5 shows a situation at time T2 after a predetermined time has elapsed from time T1 shown in FIG. 4. At time T2, the host vehicle M(T2) is in a situation in which a direction indicator lamp in a right direction is blinking. The host vehicle M(T2) starts a lane change based on the second target trajectory K2 by the travel control unit and performs lateral movement to the lane L2 side in order to change lanes from the lane L1 to the lane L2.

The first action plan generation unit 142 regenerates the first target trajectory K1 after travel control based on the selected one action plan (second target trajectory K2) is started. Thereby, since the other target trajectory (first target trajectory K1) is regenerated (recalculated) on the premise of a state after behavior of the host vehicle M has changed by the one target trajectory (second target trajectory K2) being executed, even when a target trajectory corresponding to instructed travel control (lane change) could not be generated until now, a possibility of being able to generate a desired target trajectory in a current situation can be increased.

When regenerating the first target trajectory K1, the first action plan generation unit 142 may regenerate the first target trajectory K1 on the basis of the one target trajectory (second target trajectory K2) selected by the selection control unit 144. In this case, the first action plan generation unit 142 acquires information on the second target trajectory K2 from the second action plan generation unit 143 or the selection control unit 144, and generates a first target trajectory K1a along the acquired second target trajectory K2 (closer to the second target trajectory K2) based on a rule basis. Thereby, on the basis of the second target trajectory K2, the first target trajectory K1a that performs a lane change can be easily generated. By the above-described control, when switching from the second target trajectory K2 to the first target trajectory K1a, it can be smoothly handed over, and a change in behavior of the host vehicle M due to switching of the target trajectory can be suppressed.

The first action plan generation unit 142 may regenerate the above-described first target trajectory K1a and also generate a first target trajectory K1b for traveling on the lane L1 (lane center) as shown in FIG. 5 as at time T1. In this way, by also generating the first target trajectory K1b for maintaining travel of the current travel lane L1, even when lane change control is stopped (canceled) due to a change in a peripheral situation or the like during execution of a lane change, it is possible to smoothly return to a center of the lane L1 by the first target trajectory K1b.

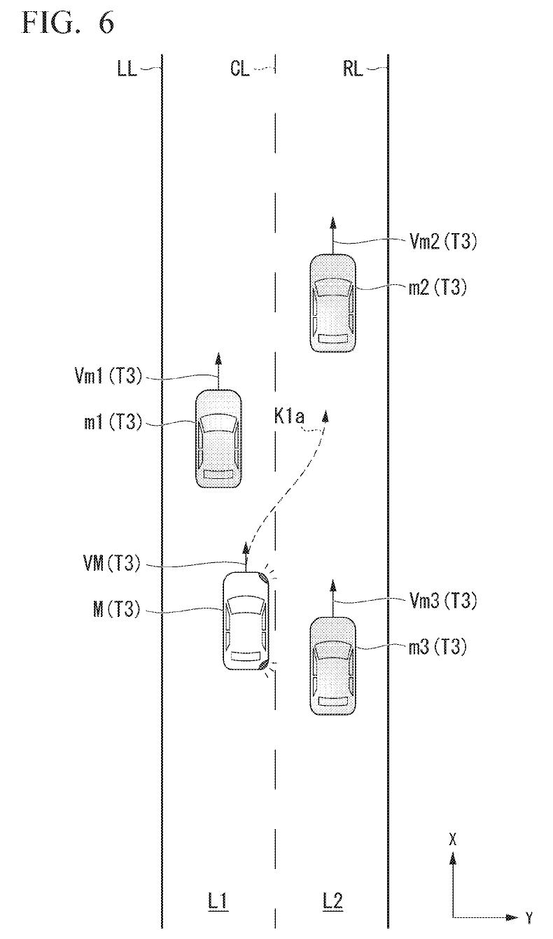

FIG. 6 is a diagram for explaining behavior of the host vehicle M when the second target trajectory K2 can no longer be generated by the second action plan generation unit 143. The example of FIG. 6 shows a situation at time T3 when a predetermined time has further elapsed from the situation at time T2 shown in FIG. 5. In the example of FIG. 6, since a positional relationship, a relative speed, and the like of the host vehicle M(T3) and the other vehicles m1(T3) to m3(T3) have changed with passage of time, a surrounding situation has changed, and it is assumed that the first action plan generation unit 142 is in a situation in which the first target trajectory K1a can be generated on a rule basis.

In this situation, for example, when a situation that is a performance limit of the trained model 182 occurs and the second target trajectory K2 can no longer be generated by the second action plan generation unit 143 (when travel control by the second target trajectory K2 becomes impossible), the selection control unit 144 switches to the first target trajectory K1a generated by the first action plan generation unit 142 and continues lane change control. A situation that is a performance limit of the trained model 182 is, for example, a situation in which information input to the trained model 182 is insufficient or a situation in which recognition accuracy of an input recognition result is deteriorating, and may be a situation in which a target trajectory cannot be generated (inference of the learning device becomes abnormal).

In this way, between time T2 and time T3, a target trajectory (action plan generation unit) to be selected is switched, but since the first action plan generation unit 142 was searching for the first target trajectory K1a so as to be able to follow the second target trajectory K2 of the second action plan generation unit 143 even in a situation where it was not selected, seamless behavior can be continued as vehicle behavior even after switching. In this way, since seamless behavior can be continued, continuity of the first driving mode (automated driving) can be improved.

### SUMMARY

In this way, in the embodiment, two target trajectories (action plans) with different logics of a rule basis and an AI basis (machine learning basis) are generated, and the target trajectory is flexibly switched according to a travel situation of the host vehicle M. For example, when the host vehicle M travels on a complex route of a general road, travel control is executed by selecting an AI-based target trajectory (second target trajectory), and when performing degraded driving (MRM) control that moves the host vehicle M to a safe place (for example, a road shoulder or the like) and stops it, a rule-based target trajectory (first target trajectory) is selected. In the embodiment, even when one target trajectory (action plan generation unit) is selected, the other action plan generation unit regenerates (operates) a target trajectory. Thereby, even when a selected target trajectory cannot be generated during predetermined travel control by the first driving mode, the first driving mode can be continued by using the other target trajectory. According to the embodiment, when the other regenerates a target trajectory, by regenerating a target trajectory so as to approach the selected one target trajectory (for example, a target trajectory for lane change), even when switching a target trajectory, current travel control can be easily continued. However, there is a case where the other cannot regenerate along the selected one target trajectory, and the other target trajectory (for example, a target trajectory that returns to a center of an original lane instead of a target trajectory for lane change) is generated. When the one target trajectory cannot be regenerated in that case, travel control that returns to a center of the original lane on the basis of the other target trajectory is executed.

In the embodiment, when it is determined by the travel control unit that travel control based on either one action plan of the first action plan (first target trajectory) and the second action plan (second target trajectory) is executable and travel control with the other action plan is not executable, the action plan generation unit 140 may regard that travel control on the basis of the other action plan is possible based on the either one action plan and regenerate the other action plan. Thereby, even when the other action plan generation unit could not obtain a valid action plan (gave up), when it is determined that travel control is possible by one action plan, the other action plan is regenerated by regarding that travel control is possible, so a possibility of handing over to the other action plan can be left even when travel control by one action plan becomes difficult, and continuity of travel control can be improved.

As described above, when it is determined that continuation of travel control is impossible (for example, one action plan cannot be generated) during travel control based on either one action plan (for example, the second action plan), the action plan generation unit 140 switches to travel control based on the other action plan (for example, the first action plan). Thereby, since there is no ending in the middle during execution of a lane change or the like, more appropriate travel control can be executed and continuity of travel control can be improved.

When switching to travel control based on the other action plan, the action plan generation unit 140 (selection control unit 144) may, for example, determine whether or not travel control based on the other action plan is possible, and when it is determined to be possible, switch to travel control based on the other action plan. In this case, the action plan generation unit 140 determines that travel control based on the other action plan is possible, for example, when the other action plan has been able to be regenerated along the selected either one action plan (for example, the second action plan), and determines that travel control based on the other action plan is impossible when the other action plan has not been able to be regenerated along the selected either one action plan. The action plan generation unit 140 may determine that travel control based on the other action plan is possible when at least one other action plan (target trajectory) has been able to be generated, and determine that travel control based on the other action plan is impossible when even one has not been able to be generated.

When it is also determined that travel control based on the other action plan is impossible (for example, the other action plan also cannot be generated), the action plan generation unit 140 may stop execution of travel control. By canceling started travel control when travel control along one action plan cannot be handed over even by the regenerated other action plan, more appropriate travel control can be executed without unreasonableness.

When lane change control is executed, the action plan generation unit 140 regenerates the other action plan after either one of the first action plan and the second action plan is selected. In a case where one action plan is capable of lane change and the other action plan is incapable of lane change and continues straight when performing lane change control, by enabling the other that gave up to also regenerate an action plan that performs a lane change so that it can follow while performing lane change control with one, a probability of completing lane change can be improved.

### Modification

In the above-described embodiment, the action plan generation unit 140 and the mode determination unit 150 may be integrally configured. In this case, for example, the mode determination unit 150 may be included in the action plan generation unit 140, or the action plan generation unit 140 may be included in the mode determination unit 150. In the embodiment, the first action plan (first target trajectory) is regenerated during execution of travel control by the second action plan (second target trajectory), but the second action plan may be regenerated during execution of the first action plan, and when the first action plan becomes unexecutable, the regenerated second action plan may be executed.

In the embodiment, when an action plan (second action plan) can no longer be generated during travel control based on one action plan (for example, the second action plan) and after switching to the other action plan (first action plan), when an action plan (second action plan) can be generated again, it may be switched to the action plan (second action plan) that has been able to be generated again, or predetermined travel control (for example, lane change control) may be completed while remaining in the other action plan (first action plan).

In the embodiment, the above-described control by the first action plan generation unit 142 and the second action plan generation unit 143 may be applied to travel control other than lane change.

### Processing Flow

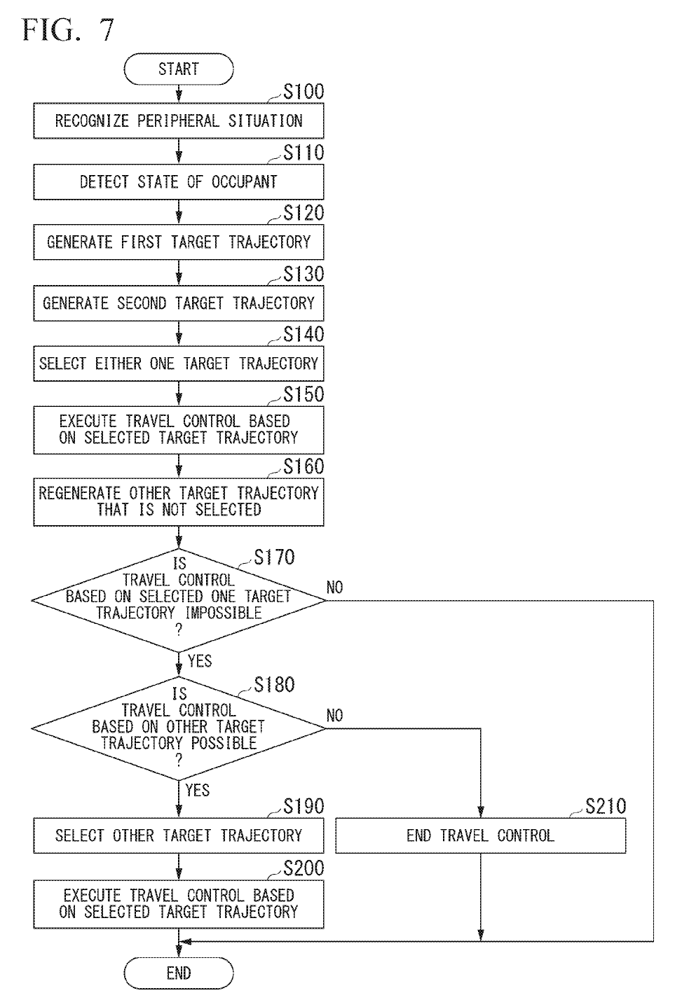

FIG. 7 is a flowchart showing an example of a flow of processing executed by the automated driving control device 100 of the embodiment. In the example of FIG. 7, among processing executed by the automated driving control device 100, travel control processing mainly using a plurality of action plans will be mainly described. The processing shown in FIG. 7 may be repeatedly executed, for example, at a predetermined timing or at a predetermined cycle during execution of automated driving or driving assistance.

In the example of FIG. 7, the recognition unit 130 recognizes a peripheral situation of the host vehicle M (step S100). Next, the driver state detection unit 152A detects a state of an occupant of the host vehicle M (step S110). Next, the first action plan generation unit 142 generates a first target trajectory (an example of a first action plan) on the basis of a peripheral situation of the host vehicle M, a state of an occupant, or the like (step S120). Next, the second action plan generation unit 143 generates a second target trajectory (second action plan) on the basis of a peripheral situation of the host vehicle M, a state of an occupant, or the like (step S130). The processing of step S120 and step S130 may be executed in reverse order or may be executed in parallel.

Next, the selection control unit 144 selects either one of the first action plan and the second action plan on the basis of a predetermined condition (step S140). The predetermined condition may be, for example, a preset priority order or may be content designated by a user. Next, the travel control unit executes travel control based on the selected action plan (step S150). Next, the action plan generation unit 140 regenerates the other action plan that is not selected (step S160). Step S150 and step S160 may be executed in reverse order.

Next, the action plan generation unit 140 determines whether or not travel control based on the selected one target trajectory is impossible (step S170). When it is determined that travel control is impossible, the selection control unit 144 determines whether or not travel control based on the other target trajectory is possible (step S180). When it is determined to be possible, the selection control unit 144 selects the other target trajectory (step S190). Next, the travel control unit executes travel control on the basis of the selected target trajectory (step S200). In the processing of step S180, when it is determined that travel control based on the other target trajectory is not possible, the travel control unit ends current travel control (step S210). In this case, for example, stop of lane change, switching control from the first driving mode to the second driving mode (manual driving), or the like is executed. Thereby, processing of the present flowchart ends. In the processing of step S170, when it is determined that travel control based on the selected one action plan is possible, current travel control is continued, and processing of the present flowchart ends.

According to the above-described embodiment, in the automated driving control device 100 (an example of a travel control device), the recognition unit 130 that recognizes a peripheral situation of the host vehicle M, the detection unit 152 that detects at least one of a state of an occupant of the host vehicle M and an instruction operation by the occupant, the action plan generation unit 140 that generates an action plan of the host vehicle M on the basis of a recognition result from the recognition unit 130 and a detection result from the detection unit 152, and the travel control unit (an example of the second control unit 160) that controls at least one of steering and speed of the host vehicle M to execute travel control of the host vehicle M on the basis of an action plan generated by the action plan generation unit 140 are provided, the action plan generation unit 140 includes the first action plan generation unit 142 that generates a first action plan on the basis of a recognition result from the recognition unit 130 and a preset rule, and the second action plan generation unit 143 that generates a second action plan with logic different from generation of the first action plan by the first action plan generation unit 142 with respect to a recognition result from the recognition unit 130, and the action plan generation unit 140 regenerates the other action plan after either one of the first action plan and the second action plan is selected, whereby a more appropriate action plan can be generated according to a situation of the host vehicle and continuity of travel control of the host vehicle can be improved.

Specifically, in the above-described embodiment, the two action plan generation units always monitor contents (output state) selected by the selection control unit 144, and even when their own action plan is not selected, regenerate their own action plan so as to be able to realize a sequence along an action plan of a counterpart. Thereby, for example, even when a counterpart action plan that is a pair enters function degradation in a state in which sequence processing cannot be performed, by using the other action plan, continued travel control and driving assistance can be realized without stopping a function.

In the embodiment, on a side that was not selected (gave up) among action plans of a rule basis and an AI basis (machine learning basis), an action plan is generated again on a premise that travel is possible on the basis of travel with a selected action plan, and by using it as a backup when travel on a selected target trajectory (route) becomes impossible (gives up), for example, continuity of travel control in the first driving mode can be improved.

The above-described embodiment can be expressed as follows.

A travel control device comprising: a storage medium storing computer-readable instructions; and

a processor connected to the storage medium,

wherein the processor executing the computer-readable instructions to:

recognize a peripheral situation of a host vehicle;

detect at least one of a state of an occupant of the host vehicle and an instruction operation by the occupant; generate an action plan of the host vehicle on the basis of a recognition result and a detection result;

control at least one of steering and speed of the host vehicle to execute travel control of the host vehicle on the basis of the generated action plan;

generate a first action plan on the basis of the recognition result and a preset rule;

generate a second action plan with logic different from generation of the first action plan with respect to the recognition result; and

regenerate the other action plan after either one of the first action plan and the second action plan is selected.

As described above, although forms for carrying out the present invention have been described using embodiments, the present invention is not limited to such embodiments at all, and various modifications and substitutions can be added within a scope not departing from the gist of the present invention.

What is claimed is:

1. A travel control device comprising:
a recognition unit that recognizes a peripheral situation of a host vehicle;
a detection unit that detects at least one of a state of an occupant of the host vehicle and an instruction operation by the occupant;
an action plan generation unit that generates an action plan of the host vehicle on the basis of a recognition result from the recognition unit and a detection result from the detection unit; and
a travel control unit that controls at least one of steering and speed of the host vehicle to execute travel control of the host vehicle on the basis of the action plan generated by the action plan generation unit,
wherein the action plan generation unit includes:
a first action plan generation unit that generates a first action plan on the basis of the recognition result from the recognition unit and a preset rule; and
a second action plan generation unit that generates a second action plan with logic different from generation of the first action plan by the first action plan generation unit with respect to the recognition result from the recognition unit, and
the action plan generation unit regenerates the other action plan after either one of the first action plan and the second action plan is selected.

2. The travel control device according to claim 1, wherein
the action plan generation unit regenerates the other action plan after travel control based on the selected one action plan is started by the travel control unit.

3. The travel control device according to claim 1, wherein
the action plan generation unit regenerates the other action plan on the basis of the selected one action plan.

4. The travel control device according to claim 1, wherein
when it is determined by the travel control unit that travel control based on either one action plan of the first action plan and the second action plan is executable and travel control with the other action plan is not executable, the action plan generation unit regards that travel control on the basis of the other action plan is possible on the basis of the either one action plan and regenerates the other action plan.

5. The travel control device according to claim 4, wherein
when it is determined that continuation of travel control is impossible during travel control based on the either one action plan, the action plan generation unit switches to travel control on the basis of the other action plan.

6. The travel control device according to claim 5, wherein
when it is determined that travel control based on the other action plan is also impossible, the travel control unit stops execution of the travel control.

7. The travel control device according to claim 5, wherein
the either one action plan is the second action plan, and
the other action plan is the first action plan.

8. The travel control device according to claim 1, wherein
the travel control includes lane change control of the host vehicle, and
the action plan generation unit regenerates the other action plan after either one of the first action plan and the second action plan is selected when the lane change control is executed.

9. A travel control method in which a computer:
recognizes a peripheral situation of a host vehicle;
detects at least one of a state of an occupant of the host vehicle and an instruction operation by the occupant;
generates an action plan of the host vehicle on the basis of a recognition result and a detection result;
controls at least one of steering and speed of the host vehicle to execute travel control of the host vehicle on the basis of the generated action plan;
generates a first action plan on the basis of the recognition result and a preset rule;
generates a second action plan with logic different from generation of the first action plan with respect to the recognition result; and
regenerates the other action plan after either one of the first action plan and the second action plan is selected.

10. A computer-readable non-transitory storage medium storing a program for causing a computer to:
recognize a peripheral situation of a host vehicle;
detect at least one of a state of an occupant of the host vehicle and an instruction operation by the occupant;
generate an action plan of the host vehicle on the basis of a recognition result and a detection result;
control at least one of steering and speed of the host vehicle to execute travel control of the host vehicle on the basis of the generated action plan;
generate a first action plan on the basis of the recognition result and a preset rule;
generate a second action plan with logic different from generation of the first action plan with respect to the recognition result; and
regenerate the other action plan after either one of the first action plan and the second action plan is selected.
